(19) United States
(12) Patent Application Publication
(10) Pub. No.: US 2026/0129419 A1
(43) Pub. Date: May 7, 2026

(54) METHOD AND ELECTRONIC DEVICE FOR MULTI-LINK OPERATION (MLO) SILENT SCAN

(71) Applicant: MEDIATEK INC., Hsinchu City (TW)

(72) Inventors: Zi-Yi WEN, Hsinchu City (TW); Jen-Chieh LIU, Hsinchu City (TW); Ying-You LIN, Hsinchu City (TW)

(21) Appl. No.: 19/366,749

(22) Filed: Oct. 23, 2025

Related U.S. Application Data
(60) Provisional application No. 63/714,944, filed on Nov. 1, 2024.

(51) Int. Cl. H04W 8/00; H04W 28/02; H04W 76/25

(52) U.S. Cl. CPC H04W 8/005; H04W 28/0268; H04W 76/25

(57) ABSTRACT

A method for a Multi-Link Operation (MLO) silent scan applicable to a station is provided. The method includes the following steps. An access point (AP) is connected through a first channel and a second channel. The first channel is within a first channel group, and the second channel is within a second channel group. Full channels within the second channel group or the first channel group are scanned alternatively, and communication with the AP through the first channel or the second channel alternatively is maintained during the scan.

### CROSS REFERENCE TO RELATED APPLICATIONS

This application claims the benefit of U.S. provisional application No. 63/714,944, Nov. 1, 2024, the entirety of which is incorporated by reference herein.

### BACKGROUND OF THE INVENTION

### Field of the Invention

The present invention relates to an electronic device, and, in particular, it relates to a method and an electronic device for a Multi-Link Operation (MLO) silent scan.

### Description of the Related Art

Wi-Fi 7's Multi-Link Operation (MLO) allows devices to simultaneously connect across multiple frequency bands, enhancing network reliability by seamlessly switching to another link if one experiences interference or performance issues. Wi-Fi scans are essential for maintaining high-quality connections during user movement such as roaming scans, so the Wi-Fi scans must be performed effectively without compromising the basic connection quality.

However, Wi-Fi scans may pause data transmission on devices, increasing latency and affecting real-time applications like Voice over Internet Protocol (VoIP) or online gaming.

### BRIEF SUMMARY OF THE INVENTION

An embodiment of the present invention provides a method for a Multi-Link Operation (MLO) silent scan applicable to a station. The method includes the following steps. A Wi-Fi 7 access point (AP) is connected through a first channel and a second channel. The first channel is within a first channel group, and the second channel is within a second channel group. Full channels within the second channel group or the first channel group are scanned alternatively, and communication with the AP through the first channel or the second channel alternatively is maintained during the scan.

According to the method described above, the step of scanning the full channels within the second channel group or the first channel group alternatively, and maintaining communication with the AP through the first channel or the second channel alternatively during the scan includes the following steps. The full channels within the first channel group are scanned in response to pausing the communication with the AP through the first channel. The communication with the AP through the first channel is resumed. The full channels within the second channel group are scanned in response to pausing the communication with the AP through the second channel. The communication with the AP through the second channel is resumed.

The method further includes the following step. The full channels within a third channel group are scanned in response to pausing the communication with the AP through the second channel

According to the method described above, the first channel group includes Wi-Fi channels near 2.4 GHz. The second channel group includes Wi-Fi channels near 5 GHz. The third channel group includes Wi-Fi channels near 6 GHz.

According to the method described above, the step of scanning the full channels within the first channel group in response to pausing the communication with the AP through the first channel includes the following step. A null frame with a positive flag is sent to the AP through the first channel, so that the AP pauses communication with the station through the first channel based on the null frame.

According to the method described above, the step of resuming the communication with the AP through the first channel includes the following step. A null frame with a negative flag is sent to the AP through the first channel, so that the AP resumes communication with the station through the first channel based on the null frame.

According to the method described above, the positive flag indicates one, which indicates that the station enters a sleep mode.

According to the method described above, the negative flag indicates zero, which indicates that the station stays up.

The method further includes the following steps. The MLO silent scan in a Simultaneous Transmit and Receive (STR) mode is performed. Alternatively, the MLO silent scan in a Multi-Link Single Radio (MLSR) mode is performed.

According to the method described above, the null frame includes null Quality of Service (QoS) data.

An embodiment of the present invention also provides an electronic device. The electronic device includes a memory and a processor. The memory store codes for a Multi-Link Operation (MLO) silent scan. The processor is electrically connected to the memory. The processor executes the codes to connect an access point (AP) through a first channel and a second channel. The first channel is within a first channel group, and the second channel is within a second channel group. The processor executes the codes to scan full channels within the second channel group or the first channel group alternatively, and remain communication with the AP through the first channel or the second channel alternatively during the scan.

According to the electronic device described above, the processor scans the full channels within the first channel group in response to pausing the communication with the AP through the first channel. The processor resumes communication with the AP through the first channel. The processor scans the full channels within the second channel group in response to pausing communication with the AP through the second channel. The processor resumes communication with the AP through the second channel.

According to the electronic device described above, the processor scans the full channels within a third channel group in response to pausing the communication with the AP through the second channel.

According to the electronic device described above, the first channel group comprises Wi-Fi channels near 2.4 GHz. The second channel group includes Wi-Fi channels near 5 GHz. The third channel group includes Wi-Fi channels near 6 GHz.

According to the electronic device described above, the processor sends a null frame with a positive flag to the AP through the first channel, so that the AP pauses communication with the station through the first channel based on the null frame.

According to the electronic device described above, the processor sends a null frame with a negative flag to the AP through the first channel, so that the AP resumes communication with the station through the first channel based on the null frame.

According to the electronic device described above, the positive flag indicates one, which indicates that the station enters a sleep mode.

According to the electronic device described above, the negative flag indicates zero, which indicates that the station stays up.

According to the electronic device described above, the processor performs the MLO silent scan in a Simultaneous Transmit and Receive (STR) mode. Alternatively, the processor performs the MLO silent scan in a Multi-Link Single Radio (MLSR) mode.

According to the electronic device described above, the null frame comprises null Quality of Service (QoS) data.

### BRIEF DESCRIPTION OF THE DRAWINGS

The present invention can be more fully understood by reading the subsequent detailed description and examples with references made to the accompanying drawings.

FIG. 1 is a flow chart of a method for a Multi-Link Operation (MLO) silent scan in accordance with some embodiments of the present invention.

FIG. 2 is a detail flow chart of step S102 in FIG. 1 in accordance with some embodiments of the present invention.

FIG. 3 is a schematic diagram of a network system 300 in accordance with some embodiments of the present invention.

FIG. 4 is a schematic diagram of a network system 400 in accordance with some embodiments of the present invention.

FIG. 5 is a timing diagram 500 of an electronic device 302 pausing communication with an AP 304 through a channel group 510 or 520 in accordance with some embodiments of the present invention.

FIG. 6 is a schematic diagram of an electronic device 302 in FIG. 3 and an electronic device 402 in FIG. 4 in accordance with some embodiments of the present invention.

### DETAILED DESCRIPTION OF THE INVENTION

In order to make the above purposes, features, and advantages of some embodiments of the present invention more comprehensible, the following is a detailed description in conjunction with the accompanying drawing.

Certain terms are used throughout the description and following claims to refer to particular components. As one skilled in the art will understand, electronic equipment manufacturers may refer to a component by different names. This document does not intend to distinguish between components that differ in name but not function. It is understood that the words “comprise”, “have” and “include” are used in an open-ended fashion, and thus should be interpreted to mean “include, but not limited to. . . ”. Thus, when the terms “comprise”, “have” or “include” used in the present invention are used to indicate the existence of specific technical features, values, method steps, operations, units or components. However, it does not exclude the possibility that more technical features, numerical values, method steps, work processes, units, components, or any combination of the above can be added.

The directional terms used throughout the description and following claims, such as: “on”, “up”, “above”, “down”, “below”, “front”, “rear”, “back”, “left”, “right”, etc., are only directions referring to the drawings. Therefore, the directional terms are used for explaining and not used for limiting the present invention. Regarding the drawings, the drawings show the general characteristics of methods, structures, or materials used in specific embodiments. However, the drawings should not be construed as defining or limiting the scope or properties encompassed by these embodiments. For example, for clarity, the relative size, thickness, and position of each layer, each area, or each structure may be reduced or enlarged.

When the corresponding component such as layer or area is referred to as being “on another component”, it may be directly on this other component, or other components may exist between them. On the other hand, when the component is referred to as being “directly on another component (or the variant thereof)”, there is no component between them. Furthermore, when the corresponding component is referred to as being “on another component”, the corresponding component and the other component have a disposition relationship along a top-view/vertical direction, the corresponding component may be below or above the other component, and the disposition relationship along the top-view/vertical direction is determined by the orientation of the device.

It should be understood that when a component or layer is referred to as being “connected to” another component or layer, it can be directly connected to this other component or layer, or intervening components or layers may be present. In contrast, when a component is referred to as being “directly connected to” another component or layer, there are no intervening components or layers present.

The electrical connection or coupling described in this disclosure may refer to direct connection or indirect connection. In the case of direct connection, the endpoints of the components on the two circuits are directly connected or connected to each other by a conductor line segment, while in the case of indirect connection, there are switches, diodes, capacitors, inductors, resistors, other suitable components, or a combination of the above components between the endpoints of the components on the two circuits, but the intermediate component is not limited thereto.

The words “first”, “second”, and “third” are used to describe components. They are not used to indicate the priority order of or advance relationship, but only to distinguish components with the same name.

It should be noted that the technical features in different embodiments described in the following can be replaced, recombined, or mixed with one another to constitute another embodiment without depart in from the spirit of the present invention.

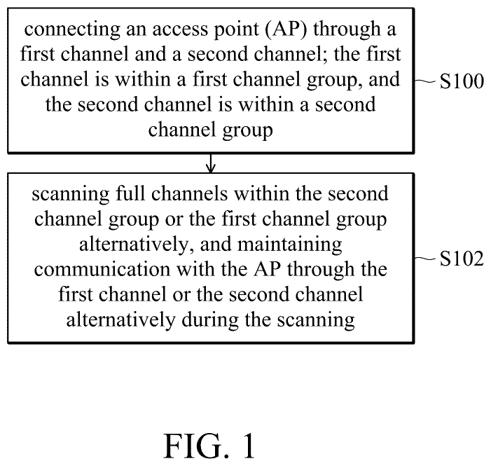

FIG. 1 is a flow chart of a method for a Multi-Link Operation (MLO) silent scan in accordance with some embodiments of the present invention. The method of present invention in FIG. 1 is applicable to a station. In some embodiments, the station may be a smart phone, tablet, or laptop, but the present invention is not limited thereto. The method of present invention in FIG. 1 includes the following steps. An access point (AP) is connected through a first channel and a second channel. The first channel is within a first channel group, and the second channel is within a second channel group (step S100). Full channels within the second channel group or the first channel group are scanned alternatively, and communication with the AP through the first channel or the second channel alternatively is maintained during the scan (step S102).

In some embodiments, the first channel group includes Wi-Fi channels near 2.4 GHz. The second channel group includes Wi-Fi channels near 5 GHz.

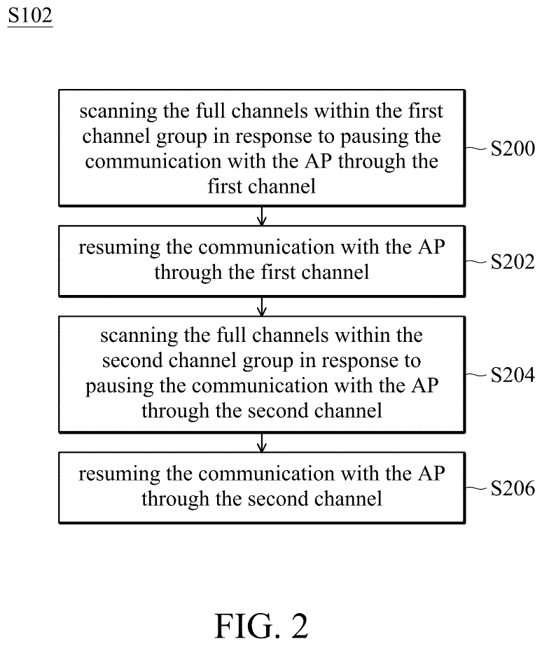

In some embodiments, step S102 includes the following steps as shown in FIG. 2. FIG. 2 is a detail flow chart of step S102 in FIG. 1 in accordance with some embodiments of the present invention. FIG. 2 is also a detail flow chart of the MLO silent scan of the present invention. That is, the MLO silent scan uses multi-link technology to conduct Wi-Fi scans with one link while maintaining traffic with another, ensuring network reliability and making the scan imperceptible. As shown in FIG. 2, the full channels within the first channel group are scanned in response to pausing the communication with the AP through the first channel (step S200). The communication with the AP through the first channel is resumed (step S202). The full channels within the second channel group are scanned in response to pausing the communication with the AP through the second channel (step S204). The communication with the AP through the second channel is resumed (step S206).

In some embodiments, the method of the present invention further scans the full channels within a third channel group in response to pausing the communication with the AP through the second channel. The third channel group includes Wi-Fi channels near 6 GHz.

In some embodiments of step S200, the method of the present invention sends a null frame with a positive flag to the AP through the first channel, so that the AP pauses communication with the station through the first channel based on the null frame. In some embodiments of step S202, the method of the present invention sends a null frame with a negative flag to the AP through the first channel, so that the AP resumes communication with the station through the first channel based on the null frame.

In some embodiments of step S204, the method of the present invention sends a null frame with a positive flag to the AP through the second channel, so that the AP pauses communication with the station through the second channel based on the null frame. In some embodiments of step S206, the method of the present invention sends a null frame with a negative flag to the AP through the second channel, so that the AP resumes communication with the station through the second channel based on the null frame.

In some embodiments, the positive flag indicates one, which indicates that the station enters a sleep mode. The negative flag indicates zero, which indicates that the station stays up. In some embodiments, the null frame includes null Quality of Service (QoS) data, but the present invention is not limited thereto.

In some embodiments, the method of the present invention further performs the MLO silent scan in a Simultaneous Transmit and Receive (STR) mode. Alternatively, the method of the present invention performing the MLO silent scan in a Multi-Link Single Radio (MLSR) mode.

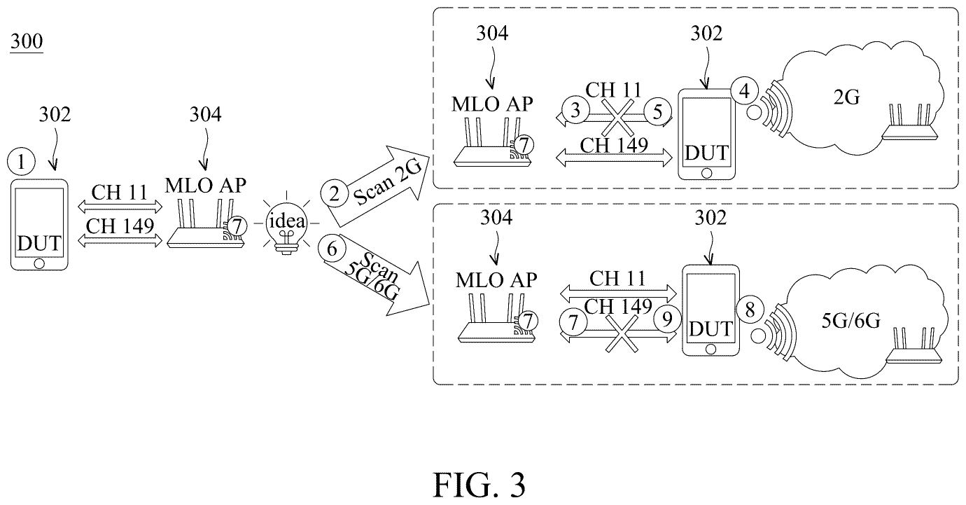

FIG. 3 is a schematic diagram of a network system 300 in accordance with some embodiments of the present invention. As shown in FIG. 3, the network system 300 includes an electronic device 302 and an AP 304. In some embodiments, the electronic device 302 is a device under test (DUT), and is a station for Wi-Fi. The AP 304 is an AP that supports MLO, which is an MLO AP. In step 1, the electronic device 302 connects the AP 304 through a first link using a channel 11 (CH 11) and a second link using a channel 149 (CH 149).

In some embodiments, the channel 11 is included in Wi-Fi channels near 2.4 GHz. The channel 149 is included in Wi-Fi channels near 5 GHz. In step 2, the electronic device 302 would like to scan the Wi-Fi channels near 2.4 GHz. Therefore, in step 3, the electronic device 302 pauses communication with the AP 304 through the channel 11. In step 4, the electronic device 302 scans full channels within the Wi-Fi channels near 2.4 GHz (marked as 2G in FIG. 3). At the same time in step 4, the electronic device 302 remains the communication with the AP 304 through the channel 149.

In step 5, the electronic device 302 resumes communication with the AP 304 through the channel 11. In step 6, the electronic device 302 would like to scan the Wi-Fi channels near 5 GHz. Therefore, in step 7, the electronic device 302 pauses communication with the AP 304 through the channel 149. In step 8, the electronic device 302 scans full channels within the Wi-Fi channels near 5 GHz (marked as 5G/6G in FIG. 3). At the same time in step 8, the electronic device 302 remains the communication with the AP 304 through the channel 11. In step 9, the electronic device 302 resumes communication with the AP 304 through the channel 149.

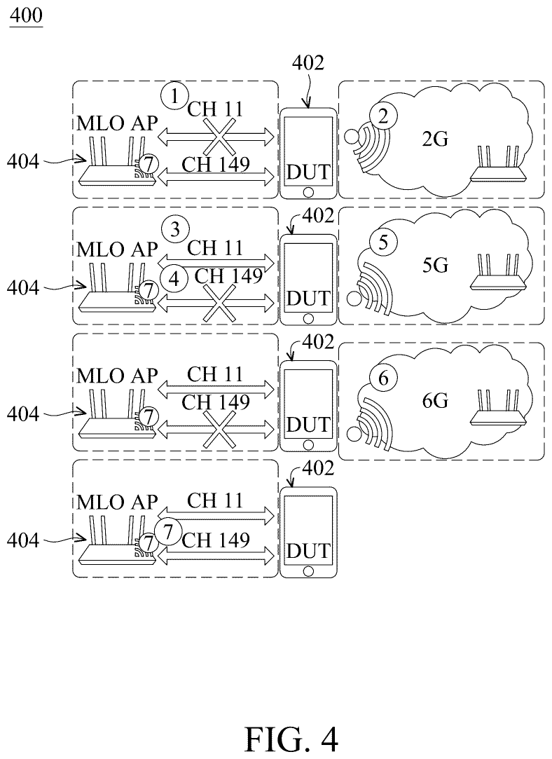

FIG. 4 is a schematic diagram of a network system 400 in accordance with some embodiments of the present invention. As shown in FIG. 4, the network system 400 includes an electronic device 402 and an AP 404. In some embodiments, the electronic device 402 is a device under test (DUT), and is a station for Wi-Fi. The AP 404 is an AP that supports MLO, which is an MLO AP. The electronic device 402 connects the AP 304 through a first link using a channel 11 (CH 11) and a second link using a channel 149 (CH 149).

In some embodiments, the channel 11 is included in Wi-Fi channels near 2.4 GHz. The channel 149 is included in Wi-Fi channels near 5 GHz. The electronic device 402 connects the AP 404 through a first link using a channel 11 (CH 11) and a second link using a channel 149 (CH 149). In step 1, the electronic device 402 pauses communication with the AP 404 through the channel 11. In step 2, the electronic device 402 scans full channels within the Wi-Fi channels near 2.4 GHz (marked as 2G in FIG. 4). At the same time in step 2, the electronic device 402 remains the communication with the AP 404 through the channel 149.

In step 3, the electronic device 402 resumes communication with the AP 404 through the channel 11. In step 4, the electronic device 402 pauses communication with the AP 404 through the channel 149. In step 5, the electronic device 402 scans full channels within the Wi-Fi channels near 5 GHz (marked as 5G in FIG. 4). In step 6, the electronic device 402 scans full channels within the Wi-Fi channels near 6 GHz (marked as 6G in FIG. 4). In step 7, the electronic device 402 resumes communication with the AP 404 through the channel 149.

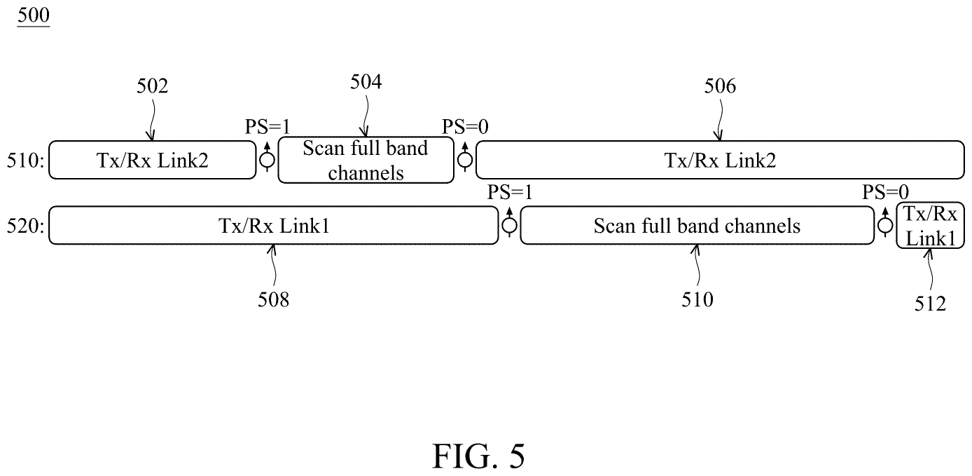

FIG. 5 is a timing diagram 500 of an electronic device 302 pausing communication with an AP 304 through a channel group 510 or 520 in accordance with some embodiments of the present invention. As shown in FIG. 5, during a period 502, the electronic device 302 performs transmitting or receiving through a second link (Link2) using a channel (for example, the channel 149 in FIG. 3) within the channel group 510. At a time point between the period 502 and a period 504, the electronic device 302 sends a null frame with a positive flag (PS=1) to the AP 304 through the channel within the channel group 510, so that the AP 304 pauses communication with the electronic device 302 through the channel within the channel group 510 based on the null frame. The positive flag indicates one, which indicates that the electronic device 302 enters a sleep mode.

During the period 504, the electronic device 302 scans full channels within the channel group 510. At a time point between the period 504 and a period 506, the electronic device 302 sends a null frame with a negative flag (PS=0) to the AP 304 through the channel within the channel group 510, so that the AP 304 resumes communication with the electronic device 302 through the channel within the channel group 510 based on the null frame. The negative flag indicates zero, which indicates that the electronic device 302 stays up. During the period 506, the electronic device 302 performs transmitting or receiving through the second link (Link2) using the channel (for example, the channel 149 in FIG. 3) within the channel group 510 again. In some embodiments, the null frame includes null Quality of Service (QoS) data, but the present invention is not limited thereto.

As shown in FIG. 5, during a period 508, the electronic device 302 performs transmitting or receiving through a first link (Link1) using a channel (for example, the channel 11 in FIG. 3) within the channel group 520. At a time point between the period 508 and a period 510, the electronic device 302 sends a null frame with a positive flag (PS=1) to the AP 304 through the channel within the channel group 520, so that the AP 304 pauses communication with the electronic device 302 through the channel within the channel group 520 based on the null frame. The positive flag indicates one, which indicates that the electronic device 302 enters the sleep mode.

During the period 510, the electronic device 302 scans full channels within the channel group 520. At a time point between the period 510 and a period 512, the electronic device 302 sends a null frame with a negative flag (PS=0) to the AP 304 through the channel within the channel group 520, so that the AP 304 resumes communication with the electronic device 302 through the channel within the channel group 520 based on the null frame. The negative flag indicates zero, which indicates that the electronic device 302 stays up. During the period 512, the electronic device 302 performs transmitting or receiving through the first link (Link1) using the channel (for example, the channel 11 in FIG. 3) within the channel group 520 again.

That is, during the overlapping period between the periods 504 and 508 along the horizontal time axis in FIG. 5, the electronic device 302 scans the full channels within the channel group 510 and remains the communication with the AP 304 through the channel within the channel group 520 simultaneously. Similarly, during the overlapping period between the periods 510 and 506 along the horizontal time axis in FIG. 5, the electronic device 302 scans the full channels within the channel group 520 and remains the communication with the AP 304 through the channel within the channel group 510 simultaneously.

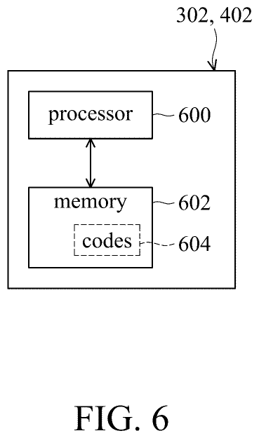

FIG. 6 is a schematic diagram of an electronic device 302 in FIG. 3 and an electronic device 402 in FIG. 4 in accordance with some embodiments of the present invention. The electronic device 302 and the electronic device 402 may be a station for Wi-Fi. As shown in FIG. 6, each of the electronic devices 302 and 402 includes a processor 600 and a memory 602. In some embodiments, the processor 600 may be an application processor, but the present invention is not limited thereto. In some embodiments, the memory 602 may be a non-volatile memory, but the present invention is not limited thereto. The memory 602 stores codes 604 for a Multi-Link Operation (MLO) silent scan. The processor 600 executes the codes to perform the following actions.

The processor 600 of the electronic device 302 connects the AP 304 through the channel 11 and the channel 149 in FIG. 3. The channel 11 is within the channel group 520, and the channel 149 is within the channel group 510 in FIG. 5. The processor 600 scans full channels within the channel group 520 or the channel group 510 alternatively, and remains communication with the AP 304 through the channel 11 or the second channel 149 alternatively during the scan. The channel 11 and channel 149 are just examples, and are not limited to the present invention.

In detail, the processor 600 scans the full channels within the channel group 520 in response to pausing the communication with the AP 304 through the channel 11. The processor 600 resumes communication with the AP 304 through the channel 11. The processor 600 scans the full channels within the channel group 510 in response to pausing communication with the AP 304 through the channel 149. The processor 600 resumes communication with the AP 304 through the channel 149.

In some embodiments, the processor 600 further scans the full channels within a third channel group in response to pausing the communication with the AP 304 through the channel 149. The channel group 520 includes Wi-Fi channels near 2.4 GHz. The channel group 510 includes Wi-Fi channels near 5 GHz. The third channel group includes Wi-Fi channels near 6 GHz.

In some embodiments, the processor 600 sends a null frame with a positive flag to the AP 304 through the channel 11, so that the AP 304 pauses communication with the electronic device 302 through the channel 11 based on the null frame. In some embodiments, the positive flag indicates one (PS=1 in FIG. 5), which indicates that the electronic device 302 enters the sleep mode. In some embodiments, the null frame includes null Quality of Service (QoS) data, but the present invention is not limited thereto.

In some embodiments, the processor 600 sends a null frame with a negative flag to the AP 304 through the channel 11, so that the AP 304 resumes communication with the electronic device 302 through the channel 11 based on the null frame. In some embodiments, the positive flag indicates zero (PS=0 in FIG. 5), which indicates that the electronic device 302 stays up.

In some embodiments, the processor 600 sends a null frame with the positive flag to the AP 304 through the channel 149, so that the AP 304 pauses communication with the electronic device 302 through the channel 149 based on the null frame. In some embodiments, the processor 600 sends a null frame with the negative flag to the AP 304 through the channel 149, so that the AP 304 resumes communication with the electronic device 302 through the channel 149 based on the null frame.

In some embodiments, the processor 600 performs the MLO silent scan in a Simultaneous Transmit and Receive (STR) mode. Alternatively, the processor 600 performs the MLO silent scan in a Multi-Link Single Radio (MLSR) mode.

The method and the electronic devices 302 and 402 for the MLO silent scan of the present invention use multi-link technology to conduct Wi-Fi scans with one link while maintaining traffic with another, ensuring network reliability and making the scan imperceptible.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for a Multi-Link Operation (MLO) silent scan, applicable to a station, comprising:
connecting an access point (AP) through a first channel and a second channel; wherein the first channel is within a first channel group, and the second channel is within a second channel group, and
scanning full channels within the second channel group or the first channel group alternatively, and maintaining communication with the AP through the first channel or the second channel alternatively during the scanning.

2. The method as claimed in claim 1, wherein the step of scanning the full channels within the second channel group or the first channel group alternatively, and maintaining communication with the AP through the first channel or the second channel alternatively during the scanning comprises:
scanning the full channels within the first channel group in response to pausing the communication with the AP through the first channel;
resuming the communication with the AP through the first channel;
scanning the full channels within the second channel group in response to pausing the communication with the AP through the second channel; and
resuming the communication with the AP through the second channel.

3. The method as claimed in claim 2, further comprising:
scanning the full channels within a third channel group in response to pausing the communication with the AP through the second channel.

4. The method as claimed in claim 3, wherein the first channel group comprises Wi-Fi channels near 2.4 GHz, the second channel group comprises Wi-Fi channels near 5 GHz, and the third channel group comprises Wi-Fi channels near 6 GHz.

5. The method as claimed in claim 2, wherein the step of scanning the full channels within the first channel group in response to pausing the communication with the AP through the first channel comprises:
sending a null frame with a positive flag to the AP through the first channel, so that the AP pauses communication with the station through the first channel based on the null frame.

6. The method as claimed in claim 2, wherein the step of resuming the communication with the AP through the first channel comprises:
sending a null frame with a negative flag to the AP through the first channel, so that the AP resumes communication with the station through the first channel based on the null frame.

7. The method as claimed in claim 5, wherein the positive flag indicates one, which indicates that the station enters a sleep mode.

8. The method as claimed in claim 6, wherein the negative flag indicates zero, which indicates that the station stays up.

9. The method as claimed in claim 1, further comprising:
performing the MLO silent scan in a Simultaneous Transmit and Receive (STR) mode; or
performing the MLO silent scan in a Multi-Link Single Radio (MLSR) mode.

10. The method as claimed in claim 5, wherein the null frame comprises null Quality of Service (QoS) data.

11. An electronic device, comprising:
a memory, configured to store codes for a Multi-Link Operation (MLO) silent scan;
a processor, electrically connected to the memory, configured to execute the codes to:
connect an access point (AP) through a first channel and a second channel; wherein the first channel is within a first channel group, and the second channel is within a second channel group; and
scan full channels within the second channel group or the first channel group alternatively, and remain communication with the AP through the first channel or the second channel alternatively during the scanning.

12. The electronic device as claimed in claim 11, wherein the processor is configured to:
scan the full channels within the first channel group in response to pausing the communication with the AP through the first channel;
resume the communication with the AP through the first channel;
scan the full channels within the second channel group in response to pausing communication with the AP through the second channel; and
resume the communication with the AP through the second channel.

13. The electronic device as claimed in claim 11, wherein the processor is configured to:
scan the full channels within a third channel group in response to pausing the communication with the AP through the second channel.

14. The electronic device as claimed in claim 13, wherein the first channel group comprises Wi-Fi channels near 2.4 GHz, the second channel group comprises Wi-Fi channels near 5 GHz, and the third channel group comprises Wi-Fi channels near 6 GHz.

15. The electronic device as claimed in claim 12, wherein the processor is configured to:
send a null frame with a positive flag to the AP through the first channel, so that the AP pauses communication with the station through the first channel based on the null frame.

16. The electronic device as claimed in claim 12, wherein the processor is configured to:
send a null frame with a negative flag to the AP through the first channel, so that the AP resumes communication with the station through the first channel based on the null frame.

17. The electronic device as claimed in claim 15, wherein the positive flag indicates one, which indicates that the station enters a sleep mode.

18. The electronic device as claimed in claim 16, wherein the negative flag indicates zero, which indicates that the station stays up.

19. The electronic device as claimed in claim 11, wherein the processor is configured to:
perform the MLO silent scan in a Simultaneous Transmit and Receive (STR) mode; or
perform the MLO silent scan in a Multi-Link Single Radio (MLSR) mode.

20. The electronic device as claimed in claim 15, wherein the null frame comprises null Quality of Service (QoS) data.
